(19) United States
(12) Patent Application Publication
(10) Pub. No.: US 2015/0032513 A1
(43) Pub. Date: Jan. 29, 2015

(54) SYSTEM AND METHOD FOR DERIVING MATERIAL CHANGE ATTRIBUTES FROM CURATED AND ANALYZED DATA SIGNALS OVER TIME TO PREDICT FUTURE CHANGES IN CONVENTIONAL PREDICTORS

(71) Applicant: THE DUN & BRADSTREET CORPORATION, Short Hills, NJ (US)

(72) Inventors: Paul D. BALLEW, Madison, NJ (US); Nipa BASU, Bridgewater, NJ (US); Anthony J. SCRIFFIGNANO, West Caldwell, NJ (US); Warwick R. MATTHEWS, Madison, NJ (US); Yiem SUNBHANICH, Lewis Center, OH (US); Karolina A. KIERZOWSKI, Linden, NJ (US); John M. NICODEMO, Bethlehem, PA (US); Bradley WHITE, Easton, PA (US); Alla KRAMSKAIA, Edison, NJ (US); Brian S. CRIGLER, Westfield, NJ (US); Xin YUAN, Basking Ridge, NJ (US); Robin DAVIES, Macungie, PA (US); Kathleen WACHHOLZ, Nazareth, PA (US); Sumanta MUKHERJEE, Edison, NJ (US); Yan LIN, New Providence, NJ (US); Paul CHIN, Whippany, NJ (US); Don FOLK, Quakertown, PA (US)

(21) Appl. No.: 14/300,315

(22) Filed: Jun. 10, 2014

Related U.S. Application Data
(60) Provisional application No. 61/858,936, filed on Jul. 26, 2013.

(51) Int. Cl. G06Q 10/06

(52) U.S. Cl. CPC G06Q 10/06375
USPC 705/7.37

(57) ABSTRACT

A system and method for deriving a material change attribute over time to predict a future change in at least one predictor, the method comprising: collecting precursor data from at least one data source; processing the precursor data by assessing at least one characteristic of the precursor data; generating at least one material change signal from the processed precursor data; evaluating the material change signal to determine the signal's value in predicting future changes in the predictor and, optionally, reverting to the collection and processing steps above to process additional precursor data; and generating at least one the material change attribute from the evaluated material change signal.

### CROSS-REFERENCED APPLICATIONS

The present disclosure claims priority to U.S. Provisional Application No. 61/858,936, filed on Jul. 26, 2013, which is incorporated herein by reference in its entirety.

### BACKGROUND

1. Field

The present disclosure generally pertains to the use of material changes to predict variation in conventional predictors of risk, opportunity, and other commercial outcomes. In particular, this disclosure relates to a system and method which generates actionable insights through detection, recognition, qualification, assessment, synthesis, linkage, inference and scoring of precursor events and tendencies from structured and unstructured data.

2. Discussion of the Background Art

The use of time to separate observation and performance data in modeling in which predictions about future outcomes are of interest is well established. In these cases, models are trained (e.g., coefficients, fit) using historical data consisting of two designations of time: observation and performance periods.

The use of attributes for prediction is well established in the analytics field. Causality need not be attributed in order to make use of associations among measures available and outcomes of interest. No presumption of causality is required of material changes. Better than random association detection is the minimal goal for the invention.

Therefore, changes in attributes used in predictive models drive changes in assessments of attributes of commercial entities. Insight into future changes in attributes (as predictors) is valuable and is the subject of this disclosure.

The present disclosure relates to the creation of new analytic solutions to generate codified and other insights that anticipate changes in business attributes and their precursors commonly utilized in assessing the risk or opportunity to enable profitable activity with a commercial entity. The insights can be leveraged in predictive modeling, profiling, segmentation, market sizing, portfolio management, prospecting and all well-established advanced analytics for decision support common to commercial risk and marketing applications relating to commercial entities.

The present disclosure also provides many additional advantages, which shall become apparent as described below.

### SUMMARY

The system and method of the present disclosure moves the generation of actionable insight feedback beyond the current score-card-based paradigm which is fed by ex post facto event information and indicia, to synthesis of “precursor data” into actionable insight. This synthesis includes detecting, recognizing, qualifying, assessing, synthesizing, linking and scoring precursor events and tendencies from structured and unstructured data.

Precursor data is data that is adjudged to be “material” according to predetermined criteria, inferential or recursive algorithms, or decision matrices but which may or may not in itself be “actionable”, in that it may not independently have a foreseeable or directly referable connection to a “direct trigger”, outcome, specific business entity or natural person, or otherwise actionable, recognized business event.

A direct trigger is a business event or indicium which would in the prior art be fed into a scorecard or analytical solution. Examples of direct triggers are declaration of bankruptcy, an incident of default on payment terms, application for credit or hiring of staff.

Examples of precursor data, defined in the present disclosure as “material changes”, may include, but not be limited to, increased contact with certain classes of vendor, changes in credit terms offered by a business, changes in frequency of company web site updates, or publication of articles by a corporation's office holders.

A method is devised for deriving a material change attribute over time to predict a future change in at least one predictor, the method comprising: collecting precursor data from at least one data source; processing the precursor data by assessing at least one characteristic of the precursor data; generating at least one material change signal from the processed precursor data; evaluating the material change signal to determine the signal's value in predicting future changes in the predictor and, optionally, reverting to the collection and processing steps above to process additional precursor data; and generating at least one the material change attribute from the evaluated material change signal.

The data source is preferably identified by use of sensing and/or learning processes. The learning processes comprise heuristics focused on human behavior and/or human learning and other methods of discernment

The processing of the precursor data preferably comprises a curation process. The curation process treats the precursor data for at least one characteristic selected from the group consisting of: time, velocity, volume, variety, and assessing veracity of the data source. The characteristic is at least one selected from the group consisting of: trending, measuring, counting events, counting sources, noting order, assessing continuity, detecting interactions, and combining or aggregating. The material change attribute is at least one selected from the group consisting of: risk, marketing, sales or other adjacencies.

A method for predicting changes in at least one predictor in the future, the method comprises: generating at least one predictor which is used to predict an outcome of interest; and generating at least one material change signal which predicts future changes in the predictor, thereby resulting in a change of the outcome of interest. The method further comprising changing a prediction of the outcome of interest due to a corresponding change in the predictor.

A computer system which generates a material change attribute over time to predict a future change in at least one predictor, the system comprising a processor which: collects precursor data from at least one data source; processes the precursor data by assessing at least one characteristic of the precursor data; generates at least one material change signal from the processed precursor data; evaluates the material change signal to determine the signal's value in predicting future changes in the predictor; and generates at least one the material change attribute from the evaluated material change signal.

A storage medium comprising instructions for controlling a processor which: collects precursor data from at least one data source; processes the precursor data by assessing at least one characteristic of the precursor data; generates at least one material change signal from the processed precursor data; evaluates the material change signal to determine the signal's value in predicting future changes in the predictor; and generates at least one the material change attribute from the evaluated material change signal.

Further objects, features and advantages of the present disclosure will be understood by reference to the following drawings and detailed description.

### BRIEF DESCRIPTION OF THE DRAWINGS

FIG. 1 is a schematic representation of the process of the present disclosure where material changes predict changes in traditional predictors, i.e. future changes in predictors, thus affecting the outcomes predicted;

FIG. 2 is a schematic representation of examples of how material changes result in future changes in predictors and the affect they have on opportunity and risk outcomes;

FIGS. 3 and 4 are schematic representations of the process flow according to the present disclosure from ingestion of data over time, to curation of such data, to analysis/synthesis of the curated data, and finally to generation of material change attributes;

FIG. 5 block diagram of a computer system used to run the process flow of the present disclosure; and

FIG. 6 is a logic flow diagram of the process according to the present disclosure.

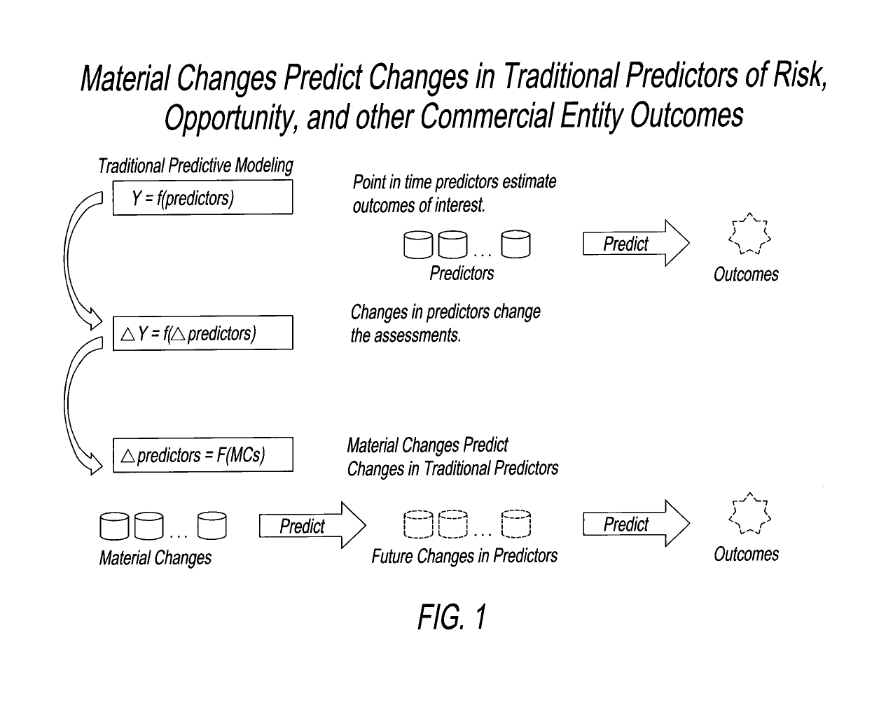

### DETAILED DESCRIPTION OF THE PREFERRED EMBODIMENT

Events about a commercial entity or collection of entities that are sensed and codified can be synthesized into insights (i.e. material changes).

There is a need to provide insights that anticipate traditional predictors and their changes. In many situations, a change in a predictor may only manifest after a material change for a commercial entity has occurred. Successful (profitable) engagement with commercial entities often requires that action be taken ahead of changes in those predictors.

The output will incorporate newly collected data changes with those observed and curated, either in raw or summarized form, and historical changes in data, which, taken together, can manifest as material changes. Thus, as data changes occur, there may be potential new material changes output about a commercial entity or entities.

To fulfill the need, the present disclosure creates analytically derived outputs (i.e. material changes), in the form of attributes and insights derived from those attributes. For example, the output may be a combination of a segment and vector for anticipated migration to another segment. Other similar insights are possible, but all are considered material change outputs.

The present disclosure is an unexpected and significant departure from the prior art in that prediction is based on changes in traditional predictors of outcomes, and possibly their antecedents, not only the outcomes themselves.

Some changes in attributes will serve dual roles, acting as both material changes and traditional predictors. This observation does not preclude the use of these changes, in the context of other changes, from generating insights that can be viewed as material changes.

Analysis is required to determine which changes in attributes, alone or in combination, across time, constitute material changes and the value of those changes in predicting variation in traditional predictors. Time-based association analytics will be utilized to assess each individual and collection of attribute changes to qualify them as material changes.

Both the definitions and relative predictiveness of the material changes will be dependent to a degree on the outcomes of interest, whether they be related to risk, opportunity or another adjacent outcome set.

Envisioned segmentations and associated prescriptive actions are product manifestations of the present disclosure, but are not limiting in terms of the use cases that may be assigned to the present disclosure.

One or more material changes can be used to define prescribed actions or strategies of engagement that improve profitability of such engagements with commercial entities. These changes are case-specific and may not all be well understood in advance of analysis and may require ad hoc analysis to define.

### Material Chances Examples

The following examples, one from sales and marketing (Opportunity) and one from credit default (Risk), are presented as a way of understanding both the construction of and the use of insights available from the present disclosure. The present disclosure requires events about a business entity or group of business entities, over time, which are discovered, curated, and recorded as new data attributes. Analysis of these historical attributes yields mathematical functions predicting yet-to-manifest changes associated with assessments of risk and opportunity.

Analysis will include the derivation of time-based attributes, such as:

Trending

Measuring

Counting events

Counting sources

Noting Order

Assessing Continuity

Detecting Interactions

Combining

Aggregating

Other

based upon the sequence of events recorded. Additional analysis will find the associations, some causal, some not, which produce the insights, summarized as measures (scores, indices, data, etc.) which alter the outlook for the assessment of a business entity.

Once the analysis for developing the functions is completed, solutions are created that leverage those functions. Solutions may be alerts, the creation of scoring attributes, or segmentations. The set of solutions enabled by the present disclosure is not limited to those listed here and are not required to be identified for the present disclosure to be established. The essence of the present disclosure is the process for creating insights that anticipate traditionally defined predictors of risk and opportunity assessments.

### Opportunity Example

Events occur over time, in sequentially or coincidentally, which can be sensed by a variety of methods. Some codification of an event detail is typically produced. For example, the day a business is established, there may be a data record of that event, as shown below. Also shown are the subsequent events, which again may each have their own codification types. For example, trade credit (TC) may be additional dollars in trade credit, an additional trade credit incidence, the appearance of the first trade credit for a business, etc. The codification may vary (nominal, interval, ordinal, etc.) so long as transformation to a form that can be subjected to established mathematical treatments is possible.

BO=business opened

TC=Additional Trade Credit

JP1=First Job Posting Period Count

JP2=Second Job Posting Period Count

SO=New Site Opening

Obs=Observation Period for Model Training

CS=Change (increase) in Annual Sales, post-observation date.

The observation period provides a division between known events and ‘unknown’ events for use in the analysis. Unknown events are actually known since archives are used in which the observation date is earlier than the analysis date.

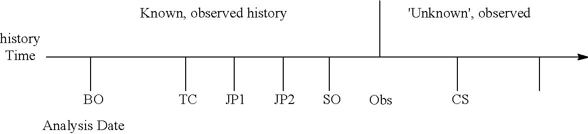

One finding, during analysis, may be that if all of the following occur for a group of businesses:

1. The business adds a trade credit within 6 months of opening

2. The business has an increasing trend in hiring

3. The business opens a new location within a year of opening

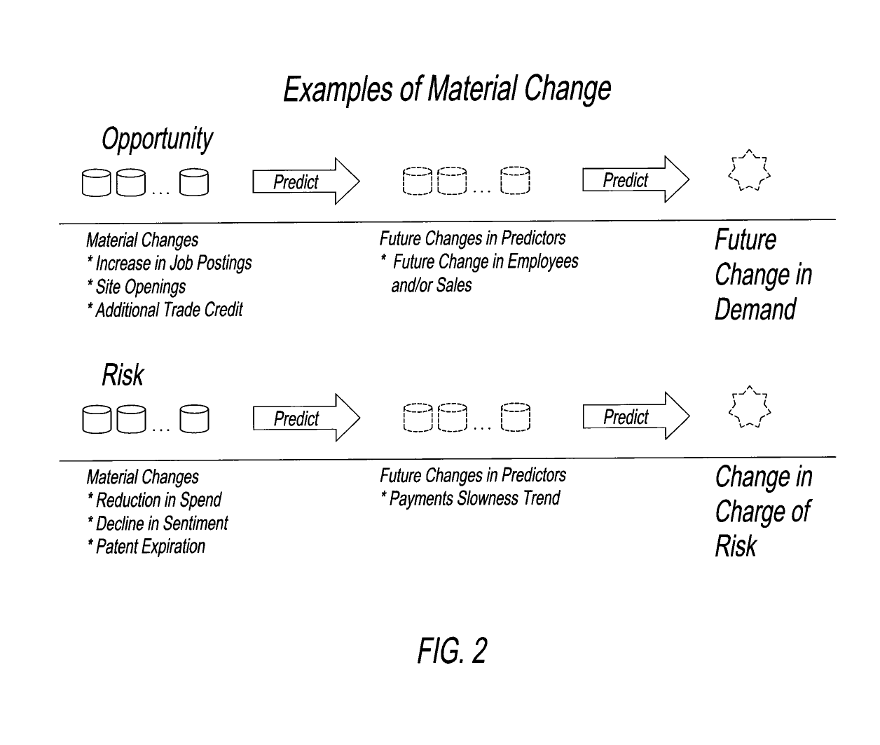

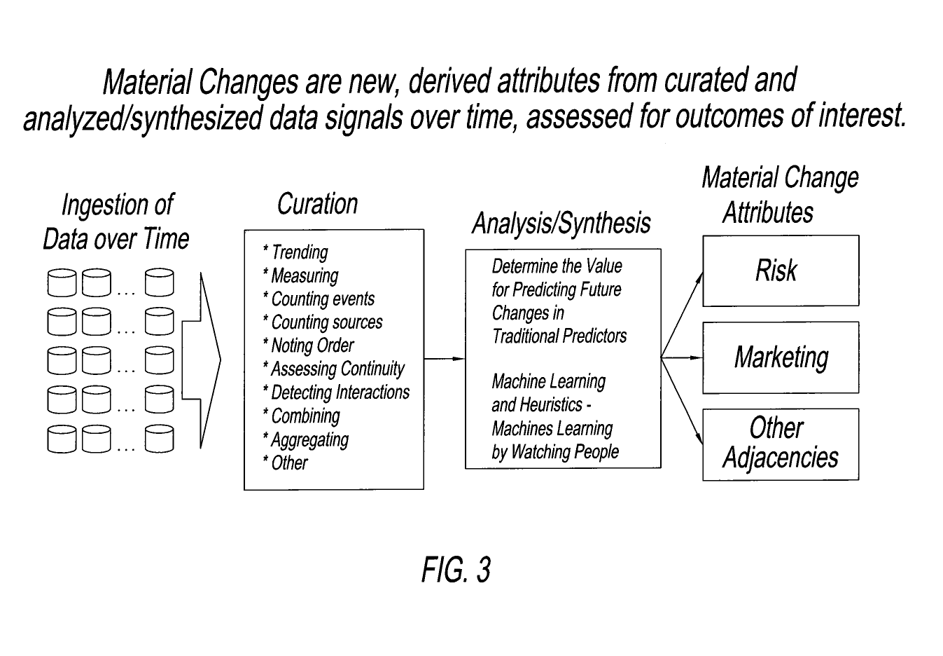

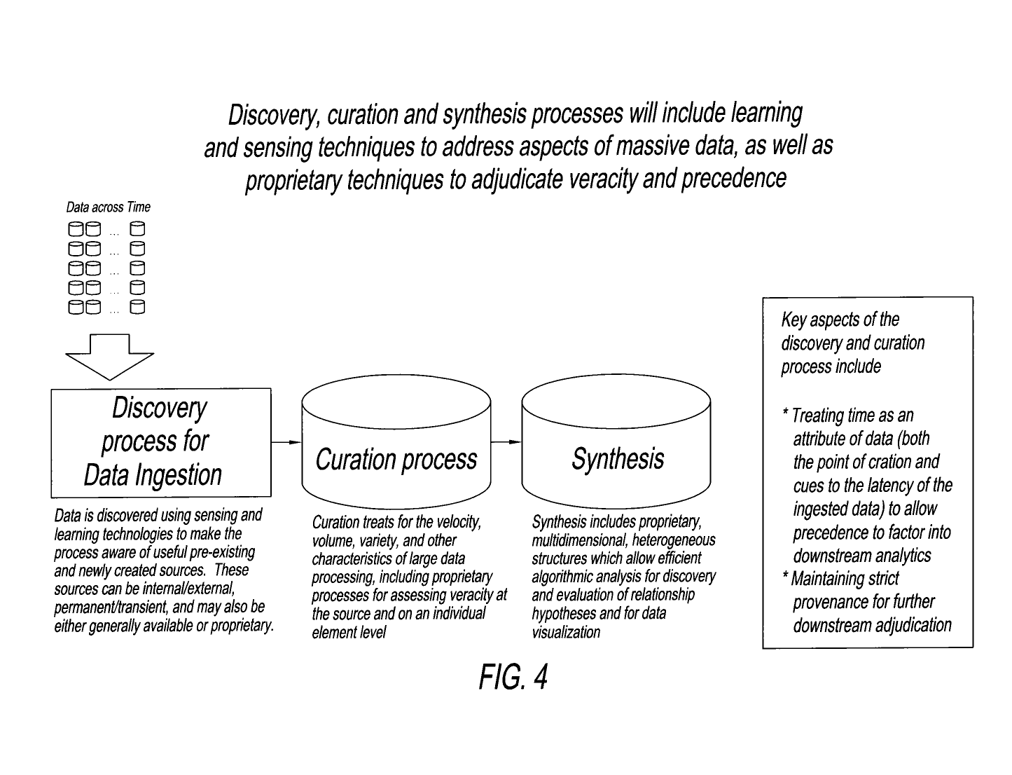

then the ‘sizes’ of these businesses, in terms of annual sales, tend to increase more often than for businesses in which these events do not happen or happen with a different sequencing or time span. Since traditional predictive solutions utilize size of business in assessing sales opportunities (demand), these results yield a material change insight that future outlook for these businesses includes increasing demand (See FIG. 2—future change in demand). One possible solution that can be created from this example is the enabling of a business segmentation that identifies groups of businesses that have outlook for increased demand before evidence of business size increase.

### Risk Example

Again, events occur over time, in sequentially or coincidentally, which can be sensed by a variety of methods.

RS=Reduction in spend

DS=Decline in sentiment

PE=Patent Expiration

Obs=Observation Period for Model Training

SP=Change (decrease) in payment promptness, post-observation date.

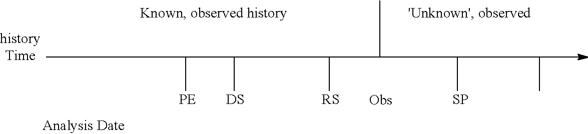

One finding, during analysis, may be that if all of the following occur for a group of businesses:

1. A key patent for this business expires

2. Sentiment analysis indicates pessimism about this business among investors

3. The business begins to pay its credit obligations more slowly

then the outlook for these businesses, in terms of future payment behavior, tend to deteriorate more often than for businesses in which these events do not happen or happen with a different sequencing or time span. Since traditional predictive solutions utilize deterioration of payment behavior in assessing credit default probability, these results yield a material change insight that future outlook for these businesses includes increasing chance of default (See FIG. 2—Change in Charge Off Risk).

One possible solution that can be created from this example is the enabling of a business segmentation that identifies groups of businesses that should be placed on a watch list for credit payment behavior.

Not only will presence of a material change signal be important, but the timing and sequencing may also influence the interpretation and use cases applicable.

A material change signal can show that an event occurred at a business, while the interaction of several material change signals can give greater insight into the business environment. A patent expiration could signal a future decline in market performance for a business. However, a patent expiration followed soon after by a reduction in business spend could signal financial difficulties. The presence of material change signals provides important information, but these signals are not occurring in a vacuum. Time between occurrences and the order in which they occur provide just as much information if not more than signal presence alone.

For example, a predictive model for the XYZ Company could be used to predict their spend propensity for IT office products. A traditional predictive model would utilize information on XYZ Company's industry, size, and credit worthiness. The model would likely show that certain industries have a higher propensity for IT office products. For instance, barber shops have a lower spend propensity for IT office products, and national banks have a higher spend propensity. Larger companies would likely have a higher propensity to spend than small companies. The reason would likely be that, all things being equal, a 200 employee company would need fewer computers than a 10,000 employee company. Finally, companies with better credit will likely spend more than companies with poor credit. Companies with better credit will have the financial ability to purchase IT office products, while companies with poor credit may not, on average.

A change in one of the predictors (e.g., industry, size, and credit worthiness) may show a change in spend propensity. If XYZ Company goes from 50 employees to 150 employees there will be an increased need for IT office products. This increase in 100 employees would feed into the standard predictive model, and output an increase in propensity to spend for IT office products, provided all other predictors remain constant.

To illustrate the importance of the insight in the material change process according to the present disclosure, one can see that the increase in spend propensity for IT office products only occurs after the increase in employee count. Only after the company brings the new employees in their doors, and provide them with the necessary work supplies such as IT office products, will the model show the company has a need for more IT office products. The material change process will allow us to anticipate the change in IT office product spend propensity before the new employees begin working, allowing for IT office product vendor action on the upcoming sales opportunity. The material change process will use material change signals to predict the change in employees at XYZ Company, and thus allowing for the prediction of a change in IT office product spend propensity. A change in employee count could be predicted by stock offerings, debt offerings, job postings, and merger and acquisition activity. A possible sequence of events where XYZ Company issues stock, and then begins posting more new open positions than in prior years could be used to predict a significant increase in employee count. That information will be used to predict a future increase in IT office product spend propensity, so an IT office product vendor could action the insight that XYZ Company will need to purchase IT office products.

The discovery process for data ingestion involves identifying data sources through discovery and learning technologies. These technologies will systematically identify and curate data that may be of use in the material change process. The data sources may be permanent and repeatedly sourced, or they may be temporary with short use cycle. Data ingestion will involve the regular processing and sourcing of the data the sensing technology discovers.

The curation process involves taking the ingested data and beginning the initial processing. The data will go through processes that will assess many characteristics. These characteristics may include trending, measuring, counting, combining, aggregating, and assessing continuity, among others. These initial processes will prepare the data for further processing, while also testing for veracity and precedence.

The analysis and synthesis stages involve developing signals that will be useful for prediction. The signals will be evaluated for relationships with the variables of interest. Those signals with value will then be passed on to the following stage.

The final stage will be taking the signals from the analysis stage and create the final predictors for the material change process. The predictors will be used in one of or several of the material change attribute buckets, risk, marketing, or other adjacencies.

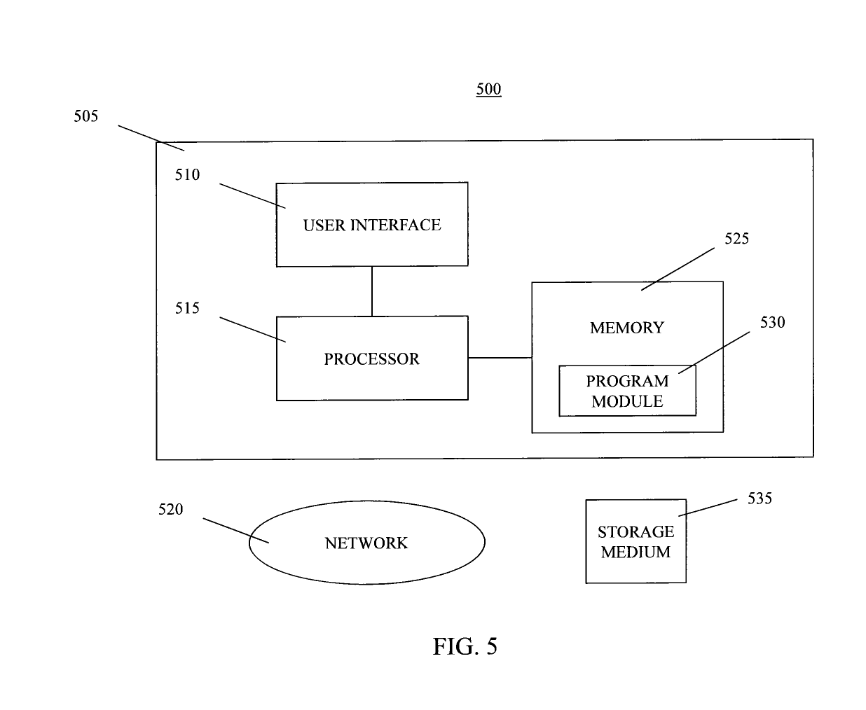

FIG. 5 is a block diagram of a system 500, for employment of the present invention. System 500 includes a computer 505 coupled to a network 3930, e.g., the Internet.

Computer 3905 includes a user interface 510, a processor 515, and a memory 520. Computer 505 may be implemented on a general-purpose microcomputer. Although computer 505 is represented herein as a standalone device, it is not limited to such, but instead can be coupled to other devices (not shown) via network 530.

Processor 515 is configured of logic circuitry that responds to and executes instructions.

Memory 520 stores data and instructions for controlling the operation of processor 515. Memory 520 may be implemented in a random access memory (RAM), a hard drive, a read only memory (ROM), or a combination thereof. One of the components of memory 520 is a program module 525.

Program module 525 contains instructions for controlling processor 515 to execute the methods described herein. For example, as a result of execution of program module 525, processor 515 derives a material change attribute over time to predict a future change in at least one predictor, by: collecting precursor data from at least one data source; processing the precursor data by assessing at least one characteristic of the precursor data; generating at least one material change signal from the processed precursor data; evaluating the material change signal to determine the signal's value in predicting future changes in the predictor and, optionally, reverting to the collection and processing steps above to process additional precursor data; and generating at least one the material change attribute from the evaluated material change signal.

The term “module” is used herein to denote a functional operation that may be embodied either as a stand-alone component or as an integrated configuration of a plurality of sub-ordinate components. Thus, program module 525 may be implemented as a single module or as a plurality of modules that operate in cooperation with one another. Moreover, although program module 525 is described herein as being installed in memory 520, and therefore being implemented in software, it could be implemented in any of hardware (e.g., electronic circuitry), firmware, software, or a combination thereof.

User interface 510 includes an input device, such as a keyboard or speech recognition subsystem, for enabling a user to communicate information and command selections to processor 515. User interface 510 also includes an output device such as a display or a printer. A cursor control such as a mouse, track-ball, or joy stick, allows the user to manipulate a cursor on the display for communicating additional information and command selections to processor 515.

Processor 515 outputs, to user interface 510, a result of an execution of the methods described herein. Alternatively, processor 515 could direct the output to a remote device (not shown) via network 530.

While program module 525 is indicated as already loaded into memory 520, it may be configured on a storage medium 535 for subsequent loading into memory 520. Storage medium 535 can be any conventional storage medium that stores program module 525 thereon in tangible form. Examples of storage medium 535 include a floppy disk, a compact disk, a magnetic tape, a read only memory, an optical storage media, universal serial bus (USB) flash drive, a digital versatile disc, or a zip drive. Alternatively, storage medium 535 can be a random access memory, or other type of electronic storage, located on a remote storage system and coupled to computer 505 via network 530.

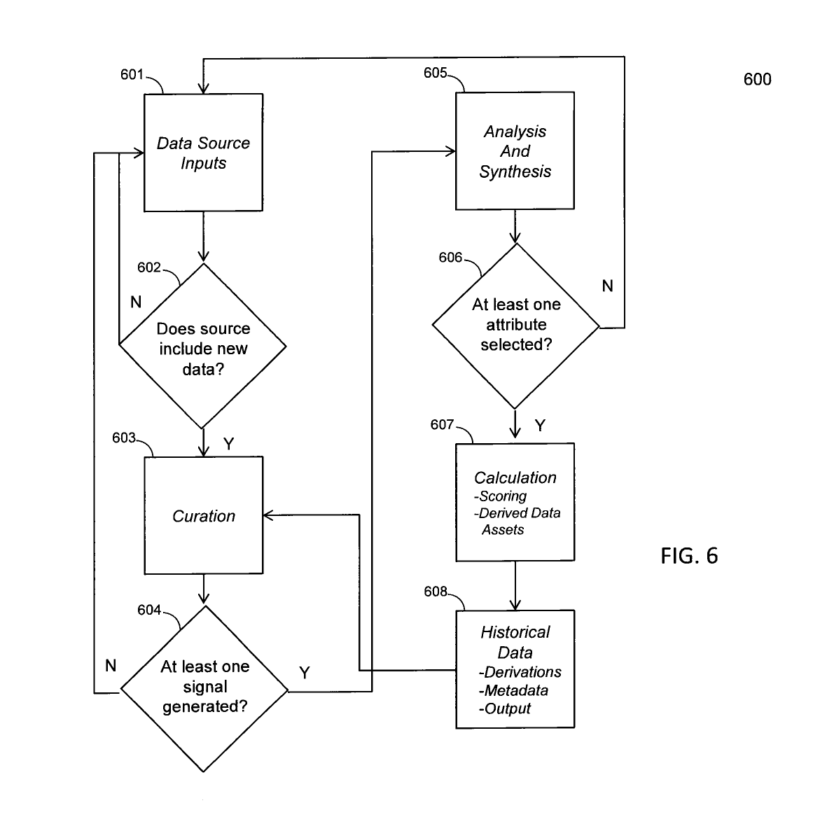

FIG. 6 is a logic flow diagram of one embodiment according to the present disclosure, wherein system 600 is initiated by discovering data from various data source inputs 601 using sensing and learning technologies to make the process aware of useful pre-existing and newly created sources. These data sources can be internal/external, permanent/transient, and may also be either generally available or proprietary. The system then determines if the data source includes new, or updated data, 602 before continuing on to the curation step 603. If not new data, then the system returns to 601. If new data is detected, then the system curates the new data 603, i.e. manipulates the new data. Data manipulations includes, but is not limited to: Trending, Measuring, Counting events, Counting sources, Noting Order, Assessing Continuity, Detecting Interactions, Combining, Aggregating, etc. All manipulations that produce material change signal values will be analyzed and synthesized for further testing. Curation will use new and updated data from 602 in conjunction with historical data from 608. If at least one new material change signal is not in 604, then the system returns to step 601. If at least one new material change signal is generated in 604, then the system proceeds to analyze and synthesize the material change signals 605.

The analysis and synthesis step 605 determines the value of signals in predicting change in traditional predictors. Material change signals that provide predictive power will then constitute material change attributes and will be applied to predict changes in traditional predictors. In step 606, there is not at least one material change attribute that provides predictive power for a traditional predictor, then the system returns to step 601. However, if step 606 determines that at least one attribute provides predictive power for a traditional predictor, than the system proceeds to calculate 607, for example, scoring or derived data assets. That is, attributes will be used in the calculation of scores and other derived data assets. Such scores and other derived data assets from 607 will generate at least one of the following: historical data, derivations, metadata, outputs, or combinations thereof. Such stored data will flow back into curation process 603, thereby generating for new and updated data.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A computer implemented method for deriving a material change attribute over time to predict a future change in at least one predictor, said method comprising:
collecting precursor data from at least one data source;
processing said precursor data by assessing at least one characteristic of said precursor data;
generating at least one material change signal from the processed precursor data;
evaluating said material change signal to determine the signal's value in predicting future changes in said predictor; and
generating at least one said material change attribute from the evaluated material change signal.

2. The method according to claim 1, wherein said data source is identified by use of sensing and/or learning process.

3. The method according to claim 2, wherein said learning process comprises heuristics focused on human behavior and/or human learning.

4. The method according to claim 1, wherein said processing of said precursor data comprises a curation process.

5. The method according to claim 1, wherein said characteristic is at least one selected from the group consisting of: trending, measuring, counting events, counting sources, noting order, assessing continuity, detecting interactions, and combining aggregating.

6. The method according to claim 4, wherein said curation process treats said precursor data for at least one characteristic selected from the group consisting of: time, velocity, volume, variety, and assessing veracity of said data source.

7. The method according to claim 1, wherein said material change attribute is at least one selected from the group consisting of: risk, marketing, sales and other adjacencies.

8. The method according to claim 1, further comprising reverting to the collection and processing steps to process additional precursor data

9. A method for predicting changes in at least one predictor in the future, said method comprises:
generating at least one predictor which is used to predict an outcome of interest; and
generating at least one material change signal which predicts future changes in said predictor, thereby resulting in a change of said outcome of interest.

10. The method according to claim 9, further comprising changing a prediction of said outcome of interest due to a corresponding change in said predictor.

11. A computer system which generates a material change attribute over time to predict a future change in at least one predictor, said system comprising:
a processor which:
collects precursor data from at least one data source;
processes said precursor data by assessing at least one characteristic of said precursor data;
generates at least one material change signal from the processed precursor data;
evaluates said material change signal to determine the signal's value in predicting future changes in said predictor; and
generates at least one said material change attribute from the evaluated material change signal.

12. The system according to claim 11, wherein said data source is identified by use of sensing and/or learning process.

13. The system according to claim 12, wherein said learning process comprises heuristics focused on human behavior and/or human learning.

14. The system according to claim 11, wherein said processing of said precursor data comprises a curation process.

15. The system according to claim 11, wherein said characteristic is at least one selected from the group consisting of: trending, measuring, counting events, counting sources, noting order, assessing continuity, detecting interactions, and combining aggregating.

16. The system according to claim 14, wherein said curation process treats said precursor data for at least one characteristic selected from the group consisting of: time, velocity, volume, variety, and assessing veracity of said data source.

17. The system according to claim 11, wherein said material change attribute is at least one selected from the group consisting of: risk, marketing, sales and other adjacencies.

18. The system according to claim 11, further comprising reverting to the collection and processing steps to process additional precursor data.

19. A storage medium comprising instructions for controlling a processor which:
collects precursor data from at least one data source;
processes said precursor data by assessing at least one characteristic of said precursor data;
generates at least one material change signal from the processed precursor data;
evaluates said material change signal to determine the signal's value in predicting future changes in said predictor; and
generates at least one said material change attribute from the evaluated material change signal.
